(19) United States
(12) Patent Application Publication
(10) Pub. No.: US 2009/0152266 A1
(43) Pub. Date: Jun. 18, 2009

(54) Storage device and methods of assembling and utilizing the same

(76) Inventor: Lee Bernard, Houston, TX (US)

Correspondence Address: James D. Bennet, II, c/o InovativSolutions, 2607 Rosemary Court, Pearland, TX, 77584, US

(21) Appl. No.: 12/290,042

(22) Filed: Oct. 24, 2008

Related U.S. Application Data
(63) Continuation of application No. 11/251,348, filed on Oct. 14, 2005.
(60) Provisional application No. 60/618,705, filed on Oct. 14, 2004.

(51) Int. Cl. B65D 33/02; B23P 11/00

(52) U.S. Cl. 220/9.1; 29/428

(57) ABSTRACT

A storage device comprising a frame having at least a portion of the frame encompassed by a covering wherein the frame comprises a multiplicity of rods automatically controlled which configures into a three dimensional mechanism structure when activated and folds into one piece when it collapses having a floor, a roof, a front wall, a right side wall, a left side wall, and a back wall, wherein the front wall, the right side wall, the left side wall, and the back wall extend upward and connect to the roof defining a chamber therein and, a releasable fastener affixed to the front wall to allow opening of the chamber for ingress to the chamber and egress from the chamber.

### REFERENCE TO RELATED APPLICATIONS

This application is a continuation of U.S. patent application Ser. No. 11/251,348 filed Oct. 14, 2005, which claims priority of U.S. Patent Application No. 60/618,705 filed on Oct. 14, 2004 both applications of which are herein incorporated by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to methods, apparatus and products for storing goods and methods of assembling and utilizing such apparatus and products.

2. Description of the Related Art

Oftentimes it is desirable to use a storage device to protect, store and preserve items of everyday living, in the presence of inclement or dangerous (i.e. rising water, flooding, etc.) weather or likewise provide shelter for humans and protect, store and preserve food, goods and vehicles. There is a wide variety of coverings, bags, tents, refrigerated enclosures, insulated enclosures and systems and methods for sheltering, protecting and storing items with regard to the aforementioned conditions. However, none of the previous applications for those conditions provide a versatile device to address the various storage needs or environmental conditions. Each application offers a specialized storing function unique within itself. Another obstacle is the laborious effort necessary to make or deploy the storage device or shelter and difficulty of transporting and handling due to weight or apparatus complexity needed to assemble or both. Yet another problem is durability and longevity of use and operation of the prior art. At times during protection or storing time frames, the protective shield offered by the prior art is not ruggedized and lacks adequate strength or stability leading to loss of integrity allowing undesirable atmospheric conditions to encroach the confining limits of the protective shield. The encroaching atmospheric conditions threaten the storage device's ability to protect, store and preserve items and provide shelter for humans in the presence of the various storage needs or environmental conditions.

In view of the foregoing, it would be an advancement in the art to provide a novel, lightweight, portable and rugged storage bag wherein the structure features a lightweight configured to framework which can be remotely and automatically mechanized and configured into a deployed structure creating a chamber of various lengths and sizes to store food, goods, vehicles or create a human shelter to address the various storage needs, weather or environmental conditions. Another advancement in the art would be to provide a storage device with a capability and adaptability to remotely store and control temperature to preserve items and provide adequate and comfortable human shelter as composite product or while employed for separate uses or purposes.

### BRIEF SUMMARY OF THE INVENTION

According to one embodiment there is provided a frame having at least a portion of the frame encompassed by a covering, wherein the frame comprises a multiplicity of rods configured into a three dimensional mechanism structure having a floor, a roof, a front wall, a right side wall, a left side wall, and a back wall. The front wall, the right side wall, the left side wall, and the back wall extend upward and connect to the roof defining a chamber therein. A releasable fastener is affixed to the front wall to allow opening of said chamber for ingress to said chamber and egress from said chamber.

According to another embodiment there is provided a method of assembling a storage device. The method includes interlocking a multiplicity of rods with fasteners configured into a three dimensional mechanism, wherein a chamber is defined by a covering encompassing a mechanism having a releasable fastener affixed to a front wall of the chamber; and connecting an actuator to the mechanism, wherein the actuator is connected to an electronic signal receiver.

According to even another embodiment there is provided a method of operating a storage device, wherein the device comprises a three dimensional mechanism encompassed by a covering to define a chamber therein, wherein said chamber is suitable for an opening in front of said device. Operating the device comprises the steps of: opening the chamber; positioning items within the interior of the chamber to allow the diffusion of a flowing fluid element, closing the chamber and monitoring temperature of the chamber with temperature alert lighted solution strips on the exterior of the covering.

### BRIEF DESCRIPTION OF THE DRAWINGS

For a fuller understanding of the nature and object of the invention, reference should be made to the following detailed descriptions taken in connection with the accompanying drawings.

FIG. 1 is a perspective view of the storage device.

FIG. 2 is an illustration showing the overall frame structure of the present invention.

FIG. 3 illustrates a perspective view of the storage device with a ground base board unit.

FIG. 3A illustrates how the ground base board unit is folded when not in use.

FIG. 4 is an enlarged rear view of the storage device.

FIG. 5A illustrates an enlarged view of the tie-down strap.

FIG. 5B is an illustration showing the overall frame structure of the storage device.

FIG. 5C is an illustration of how the storage device collapses.

FIG. 5D illustrates the storage device folded for storage.

FIG. 6 illustrates and enlarged view of the automatic signal transmitter.

FIG. 7 illustrates stored items in the storage device interior.

### DETAILED DESCRIPTION OF THE INVENTION

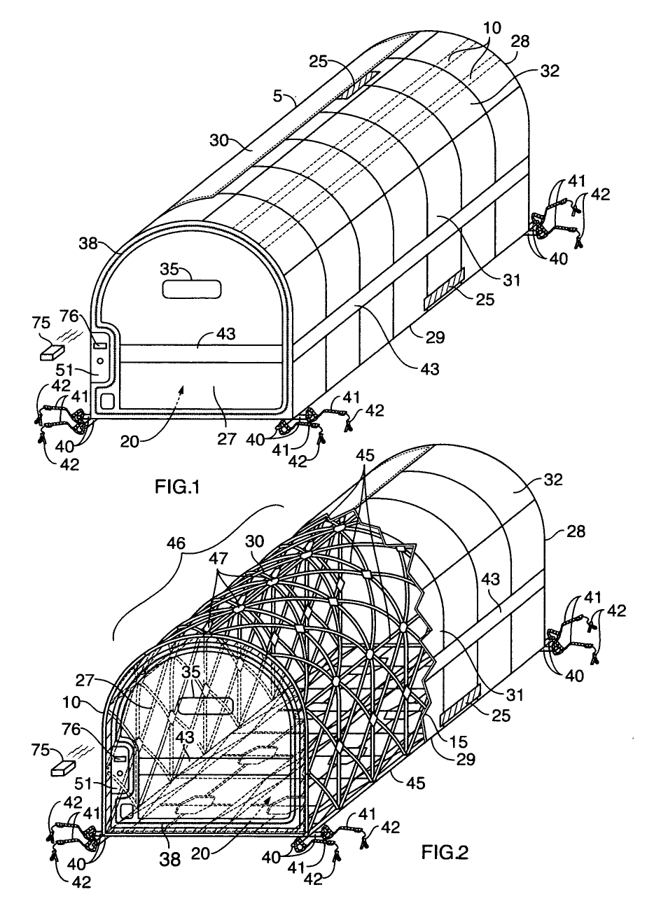

Referring now to FIGS. 1 and 2, in which like numerals identify similar parts throughout, it will be seen that there is shown a perspective view of the present invention storage device 5. According to one non-limiting embodiment, device 5 includes a structure 10 (shown on FIG. 2) having at least a portion encompassed by a covering 15 (shown on FIG. 2). Covering 15 may comprise any desirable material including water proof, water resistant, water permeable or impermeable. Preferably covering 15 is waterproof. Covering 15 may encompass part of or all of structure 10. For example, in the embodiment as shown in FIG. 1, all of structure 10 is encompassed defining chamber 20 therein. Chamber 20 varies in size and length to completely encompass the contents to be stored.

More specifically chamber 20 is defined by a front wall 27, back wall 28, floor 29, left wall 30, right wall 31 and roof 32. Front wall 27 may further include a window 35 mounted into front wall 27. Window 35 may be made of a made of a non-transparent, semi-transparent or transparent material should it be desirable to view the contents in chamber 20. Window 35 may be made of glass, acrylic, plastic or another suitable material. Additionally, front wall 27 may be adapted with automatic signal transmitter 75 for deployment or collapsing of device 5. As shown, fastener 38 may be affixed along the peripheral edges of the front wall 27. By way of example, a zipper is affixed along the perimeter edges of the front wall 27. As shown on FIG. 1, device 5 may include air vent 25 which may be placed anywhere along any wall or roof of device 5 placed and configured to allow air circulation but reduce likelihood of water entry inside chamber 20.

Affixed at each corner of structure 10 are loops 40 for attaching securing member 41 and appendage 42 to loops 40. Appendage 42 when fastened to some anchorage prevents device 5 from drifting when influenced by wind or rising water. Appendage 42 may be an anchor, a hook, a spiral, a stake, or any non-limiting suitable appendage for the desired application. As shown, in FIGS. 1 and 2 loops 40 extend outward at each corner of structure 10.

Covering 15 (shown on FIG. 2) may be made of a any suitable material for the desired application that is waterproof, wind resistant, water repellant, mold repellant, mildew repellant, bacteria inhibitor, heat resistant, flame proof, flame resistant and flexible depending on the environment.

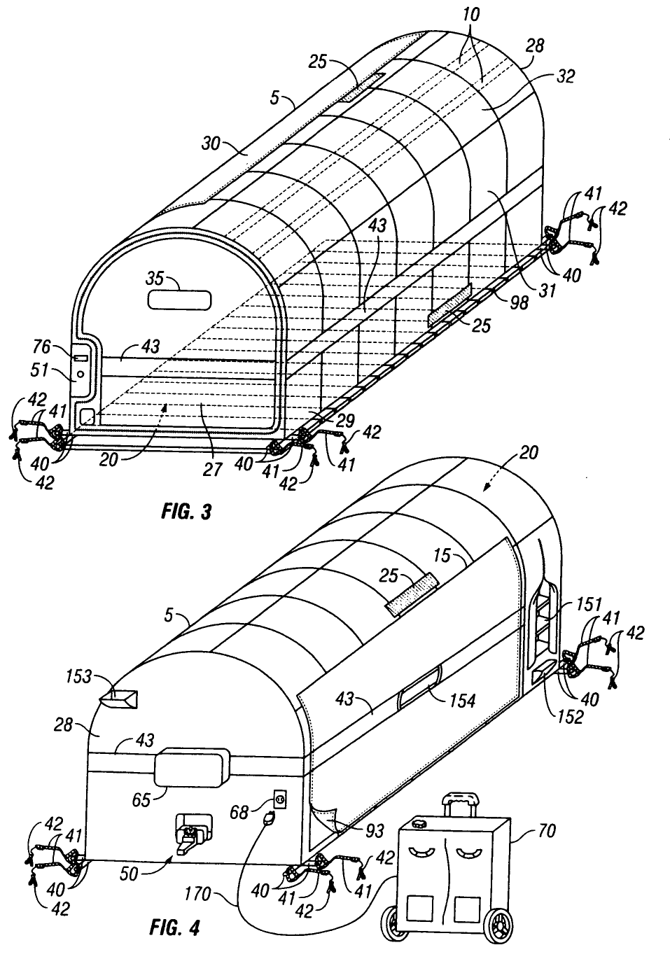

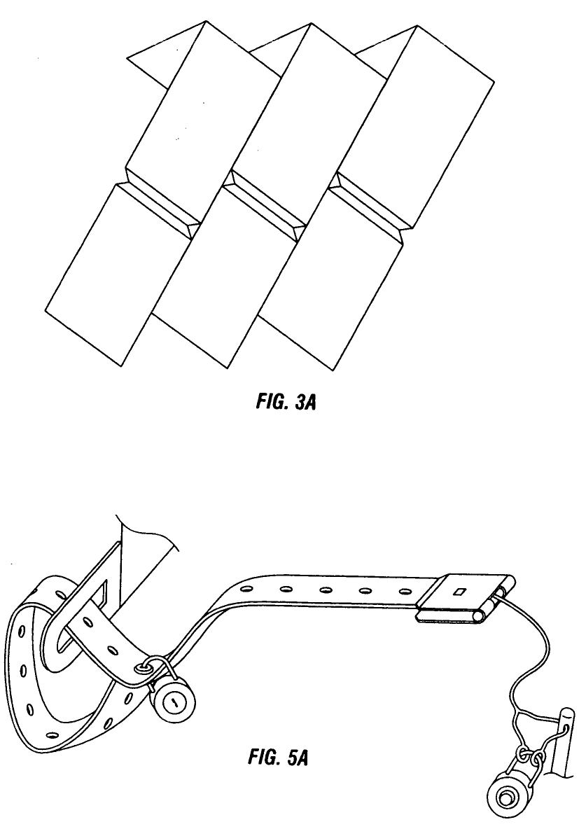

FIG. 2 illustrates one non-limiting example of structure 10. A multiplicity of rods is interconnected to form the desired shape and configuration of chamber 20. In some embodiments, as shown in FIG. 3, a non-limiting example of ground base board unit 98 serves as a substrate for extra support on rough and rocky ground surfaces. As shown in FIG. 3A illustrates ground base board unit 98 may be folded into one piece when not in use.

FIG. 4 is an enlarged rear perspective view of device 5. Attached to rear wall 28 is a faucet 50. Faucet 50 may be made of plastic, rubber or any suitable material for the desired application. Faucet 50 can be pushed in and pulled out of the unit. As shown faucet 50 fits into its own cubby hole cup. Air vent 25 may be situated anywhere along any wall or roof of device 5 placed and configured to allow air circulation but reduce likelihood of water entry inside the chamber 20. There may be a shut-off fastener inside chamber 20. The shut-off fastener may be optionally designed to seal off vent with a zipper, velcro, snaps, or any non-limiting suitable fastener for the desired application. Left wall 30 (shown in FIG. 3) may be adapted with side door 93 (shown in FIG. 4) where close confines may result from storage of large items. For example, if an automobile is stored, a releasable fastener may be opened and by using handle 154 side door 93 may be raised to allow ingress to and egress from chamber 20 through side door 93. Storage chamber 151 for actuator and other items is shown adjacent to side door 93. Located below storage chamber 151 is battery storage 152. In the event that the contents stored are liquid, liquid fill and smoke and steam relief unit 153 provides access for introducing the liquid in chamber 20. In the event the contents stored are meats for curing purposes, liquid fill and smoke and steam relief unit 153 provides a relief for any excess smoke or steam produced inside chamber 20 during the curing process. Also illustrated on FIG. 4 is power inlet connection 68 placed on back wall 28 and configured through covering 15 creating passage to chamber 20 for connection to generator 70 to provide power via power cord 170 to diffuser 65.

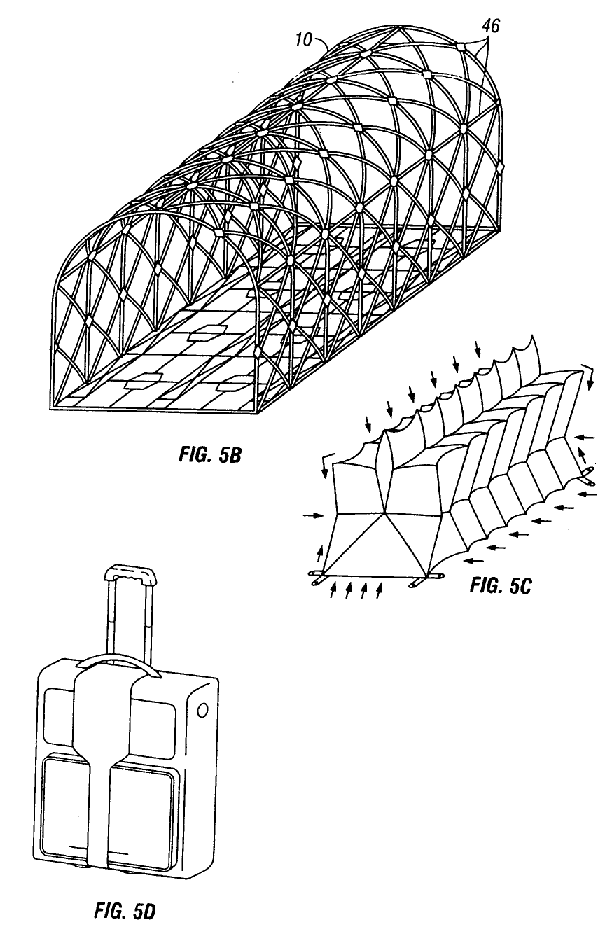

In some situations, where it may be desired to secured device 5 in place any non-limiting suitable securing member may be used, a tie down strap, a lock, latches, wire, rope, chains, tether or any non-limiting suitable securing member to attach to loops 40 or any non-limiting suitable appendage for the desired application. FIG. 5A illustrates an enlarged perspective of loops 40, securing member 41 and appendage 42 for that particular purpose. As shown in FIG. 5A, the tie is an enlongated strap with connectors at opposing ends.

FIG. 5B through FIG. 5D illustrates one non-limiting embodiment of how device 5 may be folded for easy storage. As shown in FIG. 5B structure 10 is specifically designed into sections to create mechanism 46 which easily collapses to a one piece unit folded for storage as shown in FIG. 5D.

Referring now to FIG. 2 there is shown another non-limiting embodiment having a multiplicity of rods 45 connected with fasteners 47 configured in a three dimensional mechanism 46 in an open and fully deployed position wherein mechanism 46 results in structure 10 to support covering 15. Rods 45 may comprise any desirable light weight material, for example aluminum. Fasteners 47 connecting the meeting end of rods 45 may be made of plastic or metal. As a non-limiting example, fasteners 47 may be metal. Fasteners 47 may be rivets, nuts and bolts, pins, screws or any non-limiting suitable fastener. As a non-limiting example, fasteners 47 may be rivets. Covering 15 comprises insulating layer which may comprise any non-limiting desirable material including water proof, water resistant, water permeable or impermeable and may be material that is waterproof, wind resistant, water repellant, mold repellant, mildew repellant, bacteria inhibitor, heat resistant, flame proof, flame resistant and flexible or any non-limiting material for the desired application depending on the environment.

Covering 15 is arranged in tension around structure 10 to encompass mechanism 46 defining chamber 20 by front wall 27, back wall 28, floor 29, left wall 30, right wall 31 and roof 32. Loops 40 are affixed to each lower corner of structure 10 for securing device 5 in place. Illustrated on FIG. 4 is an enlarged rear perspective view of device 5. Faucet SO is shown mounted externally to back wall 28 to drain liquid or moisture created inside chamber 20. Faucet 50 may be made of plastic, rubber or any suitable material for the desired application. Faucet 50 may be pulled in and out of back wall 28. As shown, faucet 50 fits into its own cubby hole cup. Air vent 25 may be situated anywhere along any wall or roof of device 5 placed and configured to allow air circulation but reduce likelihood of water entry inside the chamber 20. There may be a shut-off fastener inside chamber 20. The shut-off fastener may be optionally designed to seal off vent with a zipper, velcro, snaps, or any non-limiting suitable fastener for the desired application. Left wall 30 (shown in FIG. 3) may be adapted with side door 93 (shown on FIG. 4) where close confines may result from storage of large items. For example, if an automobile is stored, a releasable fastener may be opened and by using handle 154 side door 93 may be raised to allow ingress to and egress from chamber 20 through side door 93. Storage chamber 151 for actuator and other items is shown adjacent to side door 93. Located below storage chamber 151 is battery storage 152. Also illustrated on FIG. 4 is power inlet connection 68 placed on back wall 28 and configured through covering 15 creating passage to chamber 20 for connection to generator 70 to provide power via power cord 170 to diffuser 65.

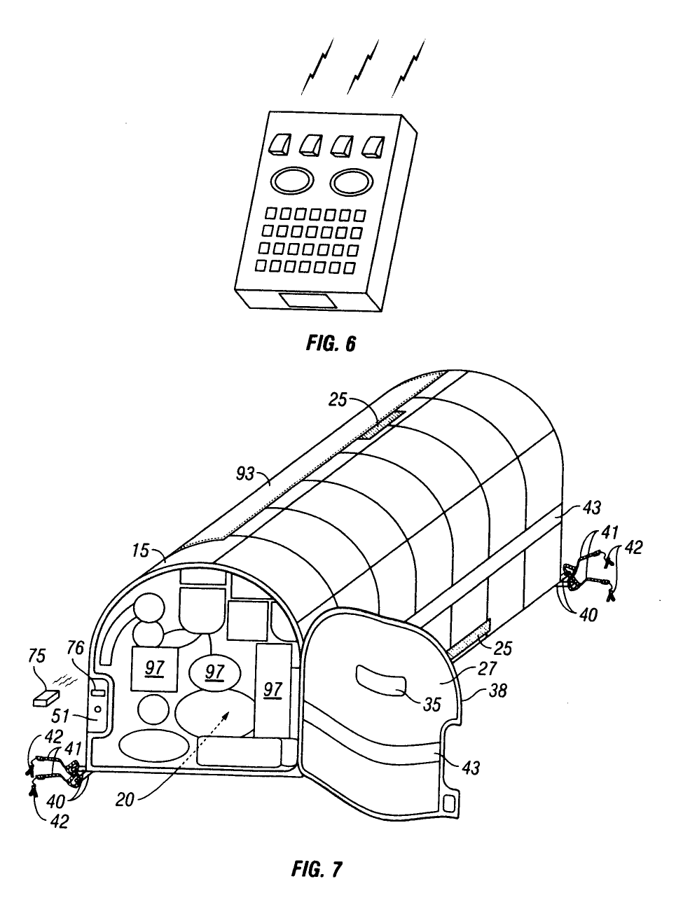

Illustrated on FIG. 2 is releasable fastener 38 affixed along opposed perimeter edges of chamber 20 opening and front wall 27. Fastener 38, when released, creates an opening allowing ingress to and egress from chamber 20. Temperature alert lighted solution strips 43 shown are affixed to the exterior of front wall 27, back wall 28, left wall 30 and right wall 31. Temperature alert lighted solution strips 43 illuminate a blue color when contents inside chamber 20 are being cooled and a red color when contents inside chamber 20 are being heated. Air vent 25 is placed and configured through covering 15 creating an air way to chamber 20. Air vent 25 is strategically placed anywhere along any wall or roof of device 5 placed and configured to allow air circulation but reduce likelihood of water entry inside chamber 20. Actuator 51 is illustrated wherein actuator 51 is connected to mechanism 46 in a manner for activation of mechanism 46. Mechanism 46 may be bending, telescopic, umbrella configuration or any non-limiting suitable configuration may be used for the desired application. Electronic signal receiver 76 is connected to actuator 51 and is placed and configured on front wall 27. Actuator 51 may be pneumatic, hydraulic or any non-limiting suitable actuator or prime mover may be used for the desired application. Actuator 51 may be remotely controlled electronically by an automatic signal transmitter 75. To activate mechanism 46, actuator 51, programmed with intelligence and connected to electronic signal receiver 76, receives a signal from automatic signal transmitter 75. When a private code is dialed into automatic signal transmitter 75, (shown enlarged on FIG. 6) the signal communicates the private code to actuator 51 through electronic signal receiver 76 to configure mechanism 46 to an up and fully deployed position or down and fully collapsed position.

Referring now to FIG. 7 there is shown yet another non-limiting embodiment showing an open chamber 20. Releasable fastener 38 may be a zipper, snapper, clamp or any non-limiting suitable fastener for the desired application. Releasing fastener 38 on front wall 27 opens chamber 20 allowing entry into chamber 20 enabling placing and positioning of items 97 and human or animal habitation, within the interior of chamber 20. Items 97 may be food, liquids, goods, vehicles or any non-limiting combination of items 97 desired to be stored. Human or animal habitation may be human or animal or any non-limiting combination of human and animal habitation desired. When items 97 are positioned in chamber 20, power source 70 may be connected to power source inlet 68 externally affixed to back wall 28 providing power to diffuser 65 as illustrated on FIG. 4. Diffuser 65 (shown on FIG. 4) may be a pump, fan, suction device, heat exchanger, radiator, intercooler or any non-limiting suitable diffuser may be used for the desired application. Power source 70 may be a generator, solar, wind, electrochemical or any non-liming suitable power source may be used for the desired application. As illustrated using automatic signal transmitter 75 a predetermined temperature may be set triggering electronic receiver 76 transmitting a signal to diffuser 65. The signal activates diffuser 65 to provide diffusion of a flowing-fluid element on the interior of chamber 20. A flowing-fluid may be any liquid or gas or any combination of liquids or gases or mixture of one or more liquids or mixture of one or more gases. Liquids may be water, freon, anti-freeze or any non-limiting suitable liquid or combination of liquids may be used for the desired application. Gases may be air, oxygen, helium, hydrogen, carbon dioxide or any non-limiting suitable gas or combination of gases may be used for the desired application. Preferably the flowing-fluid element is considered a gas. Upon positioning items 97 in chamber 20, releasable fastener 38 is refastened to perimeter edge of covering 15 allowing contained encirclement of the flowing-fluid element throughout chamber 20.

I claim as my invention:

1) A storage device for protecting contents comprising:
a frame having at least a portion of said frame encompassed by a covering, wherein said frame comprises a multiplicity of rods configured into a three dimensional mechanism structure having a floor, a roof, a front wall, a right side wall, a left side wall, and a back wall, wherein said front wall, said right side wall, said left side wall, and said back wall connect to said roof and extend upward and meet said roof defining a chamber therein; and
a releasable fastener affixed to said front wall to allow opening of said chamber for ingress to said chamber and egress from said chamber.

2) The device of claim 1 further comprising a window mounted to said front wall wherein said window is made of a non-transparent, semi-transparent or transparent material of the group consisting of glass, acrylic or plastic.

3) The device of claim 1 further comprising anchoring loops affixed to said frame for securing said device in place.

4) The device of claim 1 wherein said structure is a mechanism that collapses into a one-piece unit.

5) The device of claim 1 further comprising a faucet externally mounted to the back wall wherein said faucet is plastic.

6) The device of claim 1 wherein said mechanism structure further comprises a flat platform support.

7) The device of claim 1 wherein said mechanism structure is automated deploying said mechanism structure.

8) The device of claim 7 further comprising an actuator for said device.

9) The device of claim 1 wherein said releasable fastener is affixed along a cooperating edge between said front wall and said front opening for opening and closing said device.

10) The device of claim 1 further comprising at least one air vent through said covering placed at any location of said device.

11) The device of claim 1 wherein said covering is a material protective from the elements of the group consisting of water, wind, mold, mildew and fire.

12) The device of claim 1 wherein said covering is formed of an insulating material.

13) The device of claim 1 wherein said structure is partially or completely encompassed.

14) The device of claim 1 wherein said chamber can vary in size and length.

15) The device of claim 1 further comprising a power inlet connection externally mounted to said back wall wherein said power inlet connection is plastic.

16) The device of claim 1 wherein said front wall further comprises an electronic signal receiver panel.

17) The device of claim 1 wherein said front wall, said right wall, said left wall and said back wall further comprises temperature alert lighted solution strips.

18) The device of claim 1 further comprising a securing member selected from the group consisting of tie down straps, locks, latches, wires, ropes, chains and tethers.

19) The device of claim 18 wherein said securing member comprises:
an anchor appendage.

20) The device of claim 19 wherein said appendage is selected from the group consisting of anchors, hooks, spirals and stakes.

21) A method for assembling a storage device comprising the steps of:
interlocking a multiplicity of rods with fasteners configured into a three dimensional mechanism, wherein a chamber is defined by a covering encompassing said mechanism having a releasable fastener affixed to a front wall of said chamber; and
connecting an actuator to said mechanism, wherein said actuator is connected to an electronic signal receiver.

22) The method of claim 21 further comprising the step of affixing said electronic signal receiver panel to said front wall of said chamber;

23) The method of claim 21 further comprising the step of programming intelligence in said actuator wherein said actuator is mechanized by an automatic signal transmitter code.

24) The method of claim 21 wherein said mechanism comprises a bending, telescopic, accordion or umbrella configuration.

25) The method of claim 21 further comprising the step of affixing a flat platform support within said chamber.

26) The method of claim 21 wherein said actuator comprises a pneumatic or hydraulic prime mover.

27) The method of claim 21 wherein said releasable fastener-along a cooperating edge between said front wall and said front wall opening for opening and closing said chamber.

28) The method of claim 21 wherein said covering is a material protective of the elements of the group consisting of water, wind, mold, mildew and fire.

29) The method of claim 21 wherein said covering comprises an insulating layer.

30) The method of claim 21 comprising partially or completely encompassing said mechanism by said covering.

31) The method of claim 21 further comprising the step of affixing temperature alert lighted solution strips to said covering.

32) A method of operating a storage device wherein said device comprises a three dimensional mechanism encompassed by a covering to define a chamber therein, wherein said chamber is suitable for an opening in front of said device, comprising the steps of:
opening said chamber;
positioning of items within the interior of said chamber allowing diffusion of a flowing fluid element;
closing said chamber;
monitoring temperature of said chamber with temperature alert lighted solution strips on the exterior of said covering.

33) The method of claim 32 wherein said diffusion of said flowing fluid element is diffused by a diffuser.

34) The method of claim 32 wherein said diffusion of said flowing fluid element provides a heating source for said items.

35) The method of claim 32 wherein said diffusion of said flowing fluid element provides a cooling source for said items.

36) The method of claim 32 wherein said diffusion is regulated by controlling said temperature of said flowing fluid element with an automatic signal transmitter relaying said temperature to said diffuser, wherein said diffuser dispenses said flowing fluid element throughout said chamber.

37) The method of claim 32 wherein said strips are disposed on said exterior of said covering of said device.
